(19) United States
(12) Patent Application Publication
(10) Pub. No.: US 2006/0014051 A1
(43) Pub. Date: Jan. 19, 2006

(54) Perpendicular magnetic recording medium and method of manufacturing the same

(75) Inventors: Akiro Iso, Nagano (JP); Hiroyuki Uwazumi, Nagano (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd., Shinagawa-ku (JP)

(21) Appl. No.: 11/155,017

(22) Filed: Jun. 16, 2005

(30) Foreign Application Priority Data
Jun. 18, 2004 (JP) JPPA 2004-180355

(51) Int. Cl. G11B 5/66

(52) U.S. Cl. 428/832

(57) ABSTRACT

A perpendicular magnetic recording medium and a method of manufacturing the same include a nonmagnetic substrate, a nonmagnetic underlayer, and a magnetic layer disposed directly on the nonmagnetic underlayer. The magnetic layer is composed of ferromagnetic crystal grains having a hexagonal close-packed structure and nonmagnetic grain boundaries composed of oxide or nitride surrounding each of the ferromagnetic crystal grains. The surface energy of the nonmagnetic underlayer is made to be at least 70 mN/m. The nonmagnetic underlayer can be composed of a metal selected from rhenium, ruthenium, and osmium, or an alloy containing at least an element selected from rhenium, ruthenium, and osmium, and can have a thickness of 30 nm or less.

### BACKGROUND

A perpendicular magnetic recording system has been contemplated to achieve a higher density recording than a conventional longitudinal magnetic system. A perpendicular magnetic recording medium is mainly composed of a magnetic layer of a hard magnetic material, an underlayer for aligning the magnetic layer in an aimed direction, a protective layer for protecting the surface of the magnetic layer, and a backing layer of a soft magnetic material for concentrating the magnetic flux generated by a magnetic head for recording on the magnetic layer. A magnetic recording medium can omit the soft magnetic backing layer, but the performance of the medium is higher when the backing layer is included. The medium without a soft magnetic backing layer is called a single layer perpendicular magnetic recording medium (also called simply a single layer perpendicular medium), and the medium with a soft magnetic backing layer is called a double layer perpendicular magnetic recording medium (also called simply a double layer perpendicular medium).

A perpendicular magnetic recording medium, like a longitudinal magnetic recording medium, must have compatibility between high thermal stability and low noises to achieve high recording density. Research and development on a perpendicular magnetic recording medium are being extensively made using a magnetic recording layer made of CoCr alloy crystalline materials that are used in a magnetic layer of a longitudinal magnetic recording medium. It is also important in a perpendicular magnetic recording medium to increase the crystalline magnetic anisotropy constant Ku for improving the thermal stability and to suppress magnetic interaction between the grains, as well as minimization of the grain size in the magnetic layer for noise reduction. Therefore, researches are being made on the composition of the magnetic layer and on the underlayer disposed beneath the magnetic layer.

In this regard, a magnetic layer generally called a granular type magnetic layer is contemplated for a magnetic layer suitable for high density recording and is a subject of intensive researches. In the granular type magnetic layer, each of the ferromagnetic crystal grains is surrounded by a nonmagnetic nonmetallic substance of oxide or nitride. Because the nonmagnetic nonmetallic grain boundary physically separates the ferromagnetic crystal grains and reduces magnetic interaction between the ferromagnetic crystal grains, formation of a zigzag magnetic domain wall occurring in the transition region of recording bits is suppressed. Therefore, low noise characteristics can be attained with such a structure.

To obtain a perpendicular magnetic recording medium exhibiting a favorable read/write performance using a granular type magnetic layer, proposals have been made to control the grain size in a nonmagnetic underlayer (see for example, Japanese Unexamined Patent Application Publication No. 2003-162811), control the lattice constants of ferromagnetic crystal grains and crystals in a nonmagnetic underlayer (see for example, Japanese Unexamined Patent Application Publication No. 2003-203330), and control the thickness of a nonmagnetic underlayer (see for example, Japanese Unexamined Patent Application Publication No. 2003-77122). All these proposals pay attention to the ferromagnetic crystal grains composing the granular type magnetic layer and aim at favorable epitaxial growth of the ferromagnetic crystal grains on a nonmagnetic underlayer.

On the other hand, to achieve excellent read/write performance with a granular-type magnetic layer, the ferromagnetic crystal grains and the nonmagnetic grain boundary must be appropriately separated. In addition, fine particles and enlarged particles must be suppressed to reduce noise. Conventional techniques take advantage of the property of the material composing the nonmagnetic grain boundary that will hardly make solid solution with the ferromagnetic crystal grains to basically expect a spontaneous separation between them. Thus, we can hardly say that sufficiently studies are made on the method that actively promotes the separation between the ferromagnetic crystal grains and the material composing the ferromagnetic grain boundary.

In a double layer perpendicular medium, the nearer the distance between the magnetic layer and the soft magnetic backing layer is, the better the read/write performance. Consequently, a thinner nonmagnetic underlayer is more desirable. Nevertheless, conventional media tend to perform better with a thicker nonmagnetic underlayer. Thus, there is a need for a magnetic recording medium that uses a thinner nonmagnetic underlayer but achieving the performance of a magnetic recording medium using a thicker nonmagnetic underlayer. The present invention addresses this need.

### SUMMARY OF THE INVENTION

The present invention relates to a perpendicular magnetic recording medium, and a method of manufacturing such a medium and a magnetic recording medium thereof.

One aspect of the present invention is a perpendicular magnetic recording medium. The medium can include a nonmagnetic substrate, a nonmagnetic underlayer, and a magnetic layer disposed directly on the nonmagnetic underlayer. The magnetic layer can be composed of ferromagnetic crystal grains having a hexagonal close-packed structure and nonmagnetic grain boundaries composed of oxide or nitride surrounding each of the ferromagnetic crystal grain. The nonmagnetic underlayer can exhibit surface energy of at least 70 mN/m (milli-Newton per meter).

The nonmagnetic underlayer can be composed of a metal or alloy containing at least one element of rhenium, ruthenium, or osmium. The thickness of the nonmagnetic underlayer can be 30 nm or less.

The nonmagnetic substrate can be a strengthened glass substrate. The magnetic recording medium can include a soft magnetic backing layer between the nonmagnetic substrate and the underlayer, and an alignment control layer between the underlayer and the soft magnetic backing layer.

Another aspect of the invention is a method of forming the medium described above. The method can include the steps of depositing the nonmagnetic underlayer to exhibit surface energy of at least 70 mN/m, and depositing the magnetic layer directly on the nonmagnetic underlayer by RF sputtering using a sputtering target of a ferromagnetic material containing oxide or nitride.

Another aspect of the invention is a perpendicular magnetic recording medium formed according to the above method.

### BRIEF DESCRIPTION OF THE DRAWINGS

FIG. 1 is a schematic cross-sectional view of a perpendicular magnetic recording medium embodying the present invention.

FIG. 2 illustrates a relation between the surface energy of a nonmagnetic underlayer and coercivity (Hc) of a perpendicular magnetic recording medium.

FIG. 3 illustrates a relation between the surface energy of a nonmagnetic underlayer and a signal-to-noise ratio (SNR) of a perpendicular magnetic recording medium.

### DETAILED DESCRIPTION

A perpendicular magnetic recording medium made as described herein can exhibit an excellent read/write performance by promoting the separation between the ferromagnetic crystal grains and the nonmagnetic grain boundaries that compose the granular type magnetic layer. Such a perpendicular magnetic recording medium also can exhibit excellent read/write performance even with a reduced film thickness of the nonmagnetic underlayer. In this respect, the present inventors have made intensive studies and found that the performance of a perpendicular magnetic recording medium employing a granular type magnetic layer can be improved by enhancing the surface energy of the nonmagnetic underlayer.

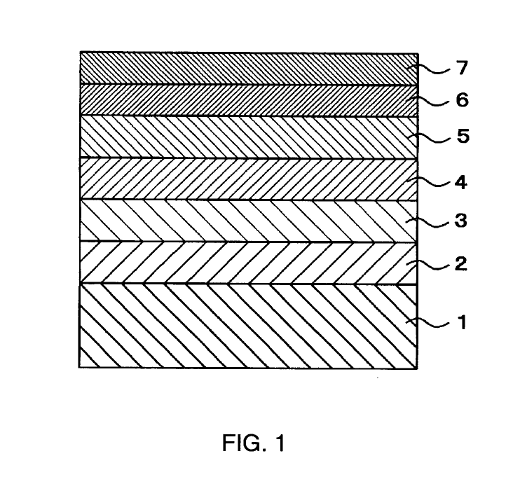

Referring to FIG. 1, a perpendicular magnetic recording medium can be constructed by sequentially laminating a soft magnetic backing layer 2, an alignment control layer 3, a nonmagnetic underlayer 4, a granular type magnetic layer 5, and a protective layer 6 on a nonmagnetic substrate 1. A lubricant layer 7 is typically formed on the protective layer 6.

The nonmagnetic substrate 1 can be composed of an aluminum alloy with NiP plating, strengthened glass, or crystallized glass commonly used in a magnetic recording medium. The substrate can also be manufactured by injection molding a plastic resin such as polycarbonate, polyolefin, or the like.

The soft magnetic backing layer 2 can be used to improve the read/write performance by controlling the magnetic flux generated by the magnetic head used for magnetic recording, although the soft magnetic backing layer can be omitted. The soft magnetic backing layer can be composed of crystalline alloys of NiFe alloy, Sendust alloy (FeSiAl), or a CoFe alloy, or micro crystalline substances of FeTaC, CoTaZr, CoFeNi, or CoNiP. A superior read/write performance can be attained using an amorphous cobalt alloy for example, CoZrNb, or CoZrTa. The optimum thickness of the soft magnetic backing layer 2 changes depending on the structure and characteristics of the magnetic head for magnetic recording. The soft magnetic backing layer that is formed by successive deposition with other layers can have a thickness in the range of 10 nm to 500 nm, taking productivity into consideration. When the backing layer is formed by plating on the nonmagnetic base plate before depositing other layers, the thickness can be increased to several μm.

The alignment control layer 3 can be positioned beneath the nonmagnetic underlayer 4 to improve alignment in the nonmagnetic underlayer. The alignment control layer can be omitted. The alignment control layer can be composed of a nonmagnetic material or a soft magnetic material. When a nonmagnetic material of Ta, Zr, or Nb is used, the thickness of 3 to 20 nm can be used to ensure the crystal matching and control the crystal grain size. When the soft magnetic backing layer 2 is formed under the alignment control layer 3, the alignment control layer can be composed of a soft magnetic material that functions as part of the soft magnetic backing layer 2. The material of the alignment control layer 3 that exhibits the soft magnetic property can be selected from a nickel-base alloy, such as NiFe, NiFeNb, NiFeB, or NiFeCr, or cobalt and cobalt-base alloy, such as CoB, CoSi, CoNi, and CoFe. A plurality of layers can be formed to separate the functions of securing the crystal matching and controlling the crystal grain size.

The nonmagnetic underlayer 4 can be provided to appropriately separate the ferromagnetic crystal grains and the nonmagnetic grain boundaries that comprise the granular type magnetic layer 5 formed directly on the underlayer, and at the same time, to suppress formation of fine and enlarged ferromagnetic crystal grains.

As described previously, controlling the nonmagnetic underlayer is important for improving the performance of a perpendicular magnetic recording medium employing a granular type magnetic layer. The performance of a perpendicular magnetic recording medium substantially changes depending on the conditions of the uppermost surface (the interface with the magnetic layer) of the nonmagnetic underlayer, in particular. The surface energy can be at least 70 mN/m, for appropriately separating the ferromagnetic crystal grains and the nonmagnetic grain boundaries that comprise the granular type magnetic layer 5. For improving the signal-to-noise ratio (SNR), the surface energy can be at least 78 mN/m. For suppressing formation of fine and enlarged ferromagnetic crystal grains and obtaining uniform ferromagnetic crystal grains, the surface energy can have isotropy in the plane of the magnetic recording medium. That is, the surface energy preferably does not have anisotropy. The nonmagnetic underlayer is preferably formed with approximately uniform thickness and with even surface.

A preferable material for composing the nonmagnetic underlayer can be selected from metals and alloys having a hexagonal close-packed (hcp) crystal structure. Among the materials, a metal of rhenium, ruthenium, or osmium, or an alloy containing at least one of rhenium, ruthenium, or osmium is particularly favorable for controlling the alignment of the granular type magnetic layer.

The thickness of the nonmagnetic underlayer can be reduced by controlling the surface energy of the nonmagnetic underlayer. The thickness of the nonmagnetic underlayer can be selected at 30 nm or less in a double layer perpendicular magnetic recording medium, which needs a small distance between the magnetic layer and the soft magnetic backing layer. A thin film thickness of a nonmagnetic underlayer also produces a favorable effect from the viewpoint of manufacturing costs. For achieving the desirable growth of the film of nonmagnetic underlayer, the thickness of at least 5 nm is preferable.

The surface energy of the nonmagnetic underlayer is controlled by the deposition conditions of the nonmagnetic underlayer, or a type and quantity of the additives to the metal or alloy of rhenium, ruthenium, or osmium. The control by deposition conditions in sputtering, for example, can be carried out through variation of the discharge power in sputtering (hereinafter called a deposition power), or the distance between the sputtering target and the nonmagnetic substrate (hereinafter called a T-S distance). Details will be described later. The control through the additives to a metal or an alloy of rhenium, ruthenium, or osmium is carried out by addition of oxygen, aluminum, tungsten, niobium, or the like.

The granular type magnetic layer 5 performs magnetic recording and essentially consists of crystal grains with ferromagnetic property and nonmagnetic grain boundaries surrounding each of the crystal grains. The grain boundary is substantially composed of an oxide or a nitride. Such a structure can be produced by deposition by sputtering using a target of a ferromagnetic alloy containing the oxide or nitride that composes the nonmagnetic grain boundary, or by deposition by reactive sputtering in argon gas containing oxygen or nitrogen using a target of a ferromagnetic alloy. A CoPt alloy is a favorable material for the material composing the ferromagnetic crystal grain, although not limited to the alloy. A CoPt alloy containing at least an element selected from Cr, Ni, or Ta in particular is preferable for reducing media noise. A preferable material composing the nonmagnetic grain boundary, on the other hand, can be selected from oxides and nitrides of at least one element of Cr, Co, Si, Al, Ti, Ta, Hf, or Zr. Such a material is preferable for forming a stable granular structure. Though the nonmagnetic grain boundary is desired to be composed of an oxide or a nitride only, containment of an element that composes the ferromagnetic crystal grain is permitted as long as the composition is within the range performing nonmagnetic property. The thickness of the magnetic layer is in the range to attain a sufficiently large head readback output and a high read/write resolution on read/write operation, although not limited to a specific range.

The granular type magnetic layer is not limited to a single layer structure, but can be a multilayer structure. A multilayer structure can be constructed by varying the material of the ferromagnetic crystal grains, or varying the ratio between the ferromagnetic crystal grains and the nonmagnetic grain boundaries through variation of the proportion of the additive of oxide or nitride. The multilayer structure allows appropriate adjustment of the balance between the signal-to-noise ratio and the other characteristics.

The protective layer 6 can be a thin film mainly or essentially composed of carbon, for example. The lubricant layer 7 can be composed of a liquid lubricant of perfluoropolyether, for example. The conditions, such as the thickness of the protective layer, and the conditions, such as the thickness of the lubricant layer, can be the same as the conditions employed in conventional magnetic media.

A magnetic recording medium having the layer structure described above, when manufactured without the substrate heating step, which is carried out in the manufacturing process of conventional magnetic recording media, still exhibits excellent perpendicular magnetic recording performance. Therefore, the manufacturing cost can be reduced owing to the simplified manufacturing process. The omission of the substrate heating further allows the use of a nonmagnetic base plate of a resin material, such as polycarbonate or polyolefin.

An antiferromagnetic film can be provided between the nonmagnetic substrate 1 and a soft magnetic backing layer 2.

Some specific examples of perpendicular magnetic recording media will follow. The examples are merely representative examples for appropriately illustrating a perpendicular magnetic recording medium embodying the present invention. The present invention accordingly should not be limited to the examples.

In Example 1, perpendicular magnetic recording media were manufactured having the structure illustrated in FIG. 1. The surface energy was controlled by changing the deposition power during the process of forming the nonmagnetic substrate 4. The deposition power was varied in a wide range for comparison. The nonmagnetic substrate 1 used was a chemically strengthened glass substrate having a smooth surface and a diameter of 2.5 inches (N5 glass substrate manufactured by HOYA Corporation). After cleaning, the substrate was introduced into a vacuum chamber of a sputtering apparatus. A soft magnetic backing layer 2 of CoZrNb having a thickness of 250 nm and subsequently an alignment control layer 3 of tantalum having a thickness of 5 nm were deposited on the substrate in that order using a well known DC sputtering technique. Then, a nonmagnetic underlayer 4 of ruthenium having a thickness of 20 nm was deposited on the control layer 3 by DC sputtering with a T-S distance of 40 mm. The nonmagnetic underlayer 4 was deposited in the conditions of various deposition powers. Subsequently, a granular type magnetic layer 5 having a thickness of 15 nm was deposited on the underlayer 4 using a well known RF sputtering technique with a Co₇₇Cr₁₀Pt₁₃ target (the subscripts indicate atomic percent) with an addition of 13 mol % SiO₂. Subsequently, a protective layer 6 of carbon having a thickness of 5 nm was deposited on the magnetic layer 5 by DC sputtering. After that, the substrate having the thus formed deposited layers was taken out from the vacuum chamber. Then, a lubricant layer 7 having a thickness of 1.5 nm was formed by applying perfluoropolyether. Here, the substrate was not heated before depositing the layers.

The surface energy of a nonmagnetic substrate was determined using the Fowkes' formula from a contact angle measured using a drop technique. The contact angle measurement was conducted using three types of liquid: pure water, α-bromonaphthalene, and methane diiodide, with a drop diameter of about 1 mm. The measurement of the contact angle was conducted on the sample having the deposited layers up to the nonmagnetic underlayer after two hour of being exposed to the atmospheric air.

The magnetic properties and the read/write performance were measured on the thus fabricated perpendicular magnetic recording medium. The coercivity Hc as a magnetic property was determined from a magnetization curve of the obtained perpendicular magnetic recording medium measured with a vibrating sample magnetometer. The SNR and other read/write characteristics were measured using a spinning stand tester equipped with a GMR head at a linear recording density of 440 kFCI (kilo flux change per inch).

Table 1 shows the deposition power during deposition of the nonmagnetic underlayer, the thickness of the nonmagnetic underlayer, the T-S distance, the surface energy (γ) of the nonmagnetic underlayer, Hc, and SNR of the perpendicular magnetic recording medium. The surface energy changes depending on the deposition power; the surface energy increases with decrease of the deposition power. The increase of the surface energy promotes the separation between the ferromagnetic crystal grains and the nonmagnetic grain boundaries that compose the granular type magnetic layer. As a result, the Hc increases and the SNR improves. A deposition power not larger than 660 W results a surface energy of at least 70 mN/m and a high Hc value of at least 3.5 kOe.

TABLE 1
(EXAMPLE 1)

| | | THICKNESS OF | T-S | | | |
|---|---|---|---|---|---|---|
| | DEPOSITION POWER | NONMAGNETIC | DISTANCE | γ | Hc | SNR |
| SAMPLES | (W) | UNDERLAYER (nm) | (mm) | (mN/m) | (kOe) | (dB) |
| 1-1 | 220 | 20 | 40 | 73.32 | 3.865 | 14.92 |
| 1-2 | 440 | 20 | 40 | 71.26 | 3.676 | 14.67 |
| 1-3 | 660 | 20 | 40 | 70.43 | 3.578 | 14.67 |
| 1-4 | 880 | 20 | 40 | 69.44 | 3.400 | 14.32 |

In Example 2, the thickness of the nonmagnetic underlayer 4 was varied. Perpendicular magnetic recording media were manufactured in the same manner as in Example 1, except that the deposition power was fixed at 220 W or 440 W and the thickness of the nonmagnetic underlayer was varied. Tables 2 and 3 show the results of the measurement similar to the Example 1. Table 2 shows the results for the deposition power of 440 W, and the Table 3 shows the results for the deposition power of 220 W. Increasing the thickness of the nonmagnetic underlayer increases the surface energy, improving the Hc and the SNR.

TABLE 2
(EXAMPLE 2)

| | | THICKNESS OF | T-S | | | |
|---|---|---|---|---|---|---|
| | DEPOSITION POWER | NONMAGNETIC | DISTANCE | γ | Hc | SNR |
| SAMPLES | (W) | UNDERLAYER (nm) | (mm) | (mN/m) | (kOe) | (dB) |
| 2-1 | 440 | 10 | 40 | 64.78 | 3.215 | 13.92 |
| 2-2 | 440 | 20 | 40 | 71.26 | 3.676 | 14.67 |
| 2-3 | 440 | 30 | 40 | 79.47 | 4.277 | 15.22 |
| 2-4 | 440 | 50 | 40 | 79.45 | 4.303 | 15.31 |

TABLE 3
(EXAMPLE 2)

| | | THICKNESS OF | T-S | | | |
|---|---|---|---|---|---|---|
| | DEPOSITION POWER | NONMAGNETIC | DISTANCE | γ | Hc | SNR |
| SAMPLES | (W) | UNDERLAYER (nm) | (mm) | (mN/m) | (kOe) | (dB) |
| 2-5 | 220 | 20 | 40 | 73.32 | 3.865 | 14.92 |
| 2-6 | 220 | 25 | 40 | 77.44 | 4.221 | 14.75 |
| 2-7 | 220 | 30 | 40 | 81.33 | 4.401 | 15.57 |
| 2-8 | 220 | 40 | 40 | 81.23 | 4.447 | 15.56 |

In Example 3, the T-S distance in the deposition process of the nonmagnetic underlayer 4 was varied. Perpendicular magnetic recording media were manufactured in the same manner as in Example 1, except that the deposition power was fixed at 440 W, the thickness of the nonmagnetic underlayer was 10 nm, and the T-S distance was varied. Table 4 shows the results of the measurement similar to Example 1. Increasing the T-S distance increases the surface energy, enhancing the Hc and the SNR. Even with a nonmagnetic underlayer having a small thickness of 10 nm, satisfactory magnetic property and read/write performance have been achieved by increasing the surface energy by controlling the T-S distance.

TABLE 4
(EXAMPLE 3)

| | | THICKNESS OF | T-S | | | |
|---|---|---|---|---|---|---|
| | DEPOSITION POWER | NONMAGNETIC | DISTANCE | γ | Hc | SNR |
| SAMPLES | (W) | UNDERLAYER (nm) | (mm) | (mN/m) | (kOe) | (dB) |
| 3-1 | 440 | 10 | 40 | 64.78 | 3.215 | 13.92 |
| 3-2 | 440 | 10 | 80 | 78.83 | 4.333 | 15.02 |

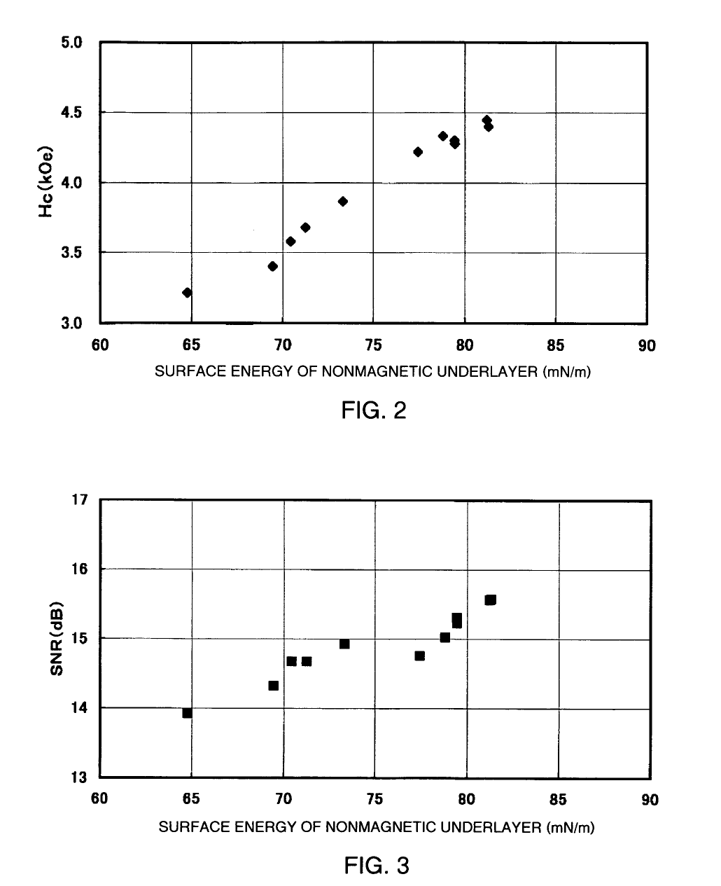

Evaluation of the relation between the surface energy and the magnetic property, and the relation between the surface energy and the read/write performance was made using the data on the perpendicular magnetic recording media of Examples 1-3. FIG. 3 shows the relation between the surface energy and the coercivity (Hc). FIG. 2 shows the relation between the surface energy and the SNR. Regardless of the deposition conditions of the nonmagnetic underlayer, the surface energy of the nonmagnetic underlayer of at least 70 mN/m achieves a favorable property of Hc at least 3.5 kOe. The surface energy of the nonmagnetic underlayer larger than 78 mN/m results a favorable characteristic of SNR larger than 15 dB.

A thinner nonmagnetic underlayer generally tends to deteriorate the magnetic property and the read/write performance. Nevertheless, even a nonmagnetic underlayer as thin as 10 nm can achieve high Hc and SNR by increasing the surface energy to a value at least 70 mN/m, by decreasing the deposition power in the sputtering process or by increasing the T-S distance. The surface energy also can be controlled by controlling the gas pressure during depositing the nonmagnetic underlayer or controlling the additives to the nonmagnetic underlayer as well as controlling the deposition power and the T-S distance.

A perpendicular magnetic recording medium constructed as described above can promote separation between ferromagnetic crystal grains and nonmagnetic grain boundaries that compose a granular type magnetic layer, and suppress fine and enlarged ferromagnetic crystal grains. Thus, a favorable read/write performance can be achieved, with high coercivity (Hc) and low noise. At the same time, the film thickness of the nonmagnetic underlayer can be reduced.

Given the disclosure of the present invention, one versed in the art would appreciate that there may be other embodiments and modifications within the scope and spirit of the present invention. Accordingly, all modifications and equivalents attainable by one versed in the art from the present disclosure within the scope and spirit of the present invention are to be included as further embodiments of the present invention. The scope of the present invention accordingly is to be defined as set forth in the appended claims.

This application is based on, and claims priority to, Japanese Application No. 2004-180355, filed on 18 Jun. 2004, and the disclosure of the priority application, in its entirety, including the drawings, claims, and the specification thereof, is incorporated herein by reference.

What is claimed is:

1. A perpendicular magnetic recording medium comprising:
a nonmagnetic substrate;
a nonmagnetic underlayer exhibiting surface energy of at least 70 mN/m; and
a magnetic layer disposed directly on the nonmagnetic underlayer and comprising ferromagnetic crystal grains having a hexagonal close-packed structure and nonmagnetic grain boundaries composed of oxide or nitride surrounding each of the ferromagnetic crystal grains.

2. The perpendicular magnetic recording medium according to claim 1, wherein the nonmagnetic underlayer is composed of metal or alloy containing at least one element of rhenium, ruthenium, or osmium.

3. The perpendicular magnetic recording medium according to claim 1, wherein the nonmagnetic underlayer has a thickness of 30 nm or less.

4. The perpendicular magnetic recording medium according to claim 2, wherein the nonmagnetic underlayer has a thickness of 30 nm or less.

5. The perpendicular magnetic recording medium according to claim 1, wherein the nonmagnetic substrate is a strengthened glass substrate.

6. The perpendicular magnetic recording medium according to claim 1, further including a soft magnetic backing layer between the nonmagnetic substrate and the underlayer.

7. The perpendicular magnetic recording medium according to claim 7, further including an alignment control layer between the underlayer and the soft magnetic backing layer.

8. A method of manufacturing a perpendicular magnetic recording medium having a nonmagnetic substrate, a nonmagnetic underlayer, and a magnetic layer, the method comprising the steps of:
depositing the nonmagnetic underlayer by DC sputtering to exhibit surface energy of at least 70 mN/m; and
depositing the magnetic layer directly on the nonmagnetic underlayer by RF sputtering using a sputtering target of a ferromagnetic material containing oxide or nitride.

9. The method according to claim 8, wherein the nonmagnetic underlayer is composed of metal or alloy containing at least one element of rhenium, ruthenium, or osmium.

10. The method according to claim 8, wherein the nonmagnetic underlayer has a thickness of 30 nm or less.

11. The method according to claim 9, wherein the nonmagnetic underlayer has a thickness of 30 nm or less.

12. The method according to claim 8, wherein the nonmagnetic substrate is a strengthened glass substrate.

13. The method according to claim 8, wherein the magnetic recording medium includes a soft magnetic backing layer between the nonmagnetic substrate and the underlayer.

14. The method according to claim 13, wherein the magnetic recording medium includes an alignment control layer between the underlayer and the soft magnetic backing layer.

15. A perpendicular magnetic recording medium formed according to the method of claim 8.
